(19) United States
(12) Patent Application Publication
(10) Pub. No.: US 2018/0215526 A1
(43) Pub. Date: Aug. 2, 2018

(54) Tamper Proof System For Dispensing Pills

(71) Applicant: John Hsu, Rowland Heights, CA (US)

(72) Inventor: John Hsu, Rowland Heights, CA (US)

(21) Appl. No.: 15/882,803

(22) Filed: Jan. 29, 2018

Related U.S. Application Data
(60) Provisional application No. 62/451,634, filed on Jan. 27, 2017.

(51) Int. Cl. B65D 83/04; G07C 9/00

(52) U.S. Cl. CPC B65D 83/0418; B65D 2255/06; G07C 9/00563

(57) ABSTRACT

A system for operating a tamper proof storage container for pills, where the storage container has a shutter mechanism that is locked by the combination of a biometric fingerprint lock and digital combination lock. The shutter is opened only upon signal from a personal or remote computer, which allows operation of the fingerprint biometric lock and the digital combination lock. The shutter will dispense only the number of pills prescribed.

### RELATED APPLICATIONS

This application claims priority and is entitled to the filing date of U.S. provisional application Ser. No. 62/451,634 filed on Jan. 27, 2017 entitled ‘Tamper Proof System for Dispensing Pills’, the contents of which are incorporated herein by reference.

### BACKGROUND

A person dies from an opioid overdose every 20 minutes. 30,000 people die a year. It is an epidemic that difficult to treat. Over 90% of people who overdose on prescription painkillers continue to use them and this use cost the US 78.5 billion dollars in 2013 (Curtis et al., Medical Care, 54:901-906 (2016) doi: 10.1097/MLR.0000000000000625).

Opiods include prescription drugs such as oxycodone (OXYCONTIN®, OXECTA®, ROXICODON EC)), oxycondone and acetaminophen (PERCOCET®, ENDOCET®, ROXICET®), hydrocodone (HYSINGLA ER®, ZOHYDRO ER®), hydrocodone and acetaminophen (LORCET®, LORTAB®, NORCO®, VICODIN®), hydromorphone (DILAUDID®), meperidine (DEMEROL®), methadone, codeine, morphine, and fentanyl as well as illegal drugs such as heroin.

Government policy to limit opioids will not treat pain nor stem the addiction problem. It will worsen the problem for addicts and compliant patients. Those who cannot get opioids turn to heroin which is becoming increasingly more dangerous with the addition of Car-Fentanyl. Studies from the CDC show that 100 million people are taking opioids for chronic pain and the government wants to limit their access to opioids. What about the multitude of studies that report cancer patients are consistently under treated for cancer pain? Is the government forsaking 100 million patients to save the 18,000 patients they are attempting to control who actually die from prescription opioids? Those 100,000 million patients need a solution to prevent their opioids used for their treatment of pain from being taken away from them.

Doctors write prescriptions correctly. Pharmacist fill prescriptions correctly. Patients receive a bottle of opioids containing 30 to 120 pills of opioids and therein lies a problem. The patient can take 1 pill or 120 pills. Patient compliance is a problem. This is further compounded by the sharing of opioids or sharing of excess opioid pills. Most of those who abuse prescription opioids get them for free from a friend or relative. However, those who are at highest risk of overdose (using prescription opioids non-medically 200 or more days a year) get them in ways that are different from those who use them less frequently. These people get opioids using their own prescriptions (27 percent), from friends or relatives for free (26 percent), buying from friends or relatives (23 percent), or buying from a drug dealer (15 percent). Those at highest risk of overdose are about four times more likely than the average user to buy the drugs from a dealer or other stranger.

The solution a smart pill dispenser. This tamper proof medical device would be only usable by the patient to whom the prescription was written because the device would be controlled by a fingerprint biometric lock. This would prevent sharing. The device security would also supplemented by a digital combination code which then allows activation of a push button dispenser similar to the shutter button on a camera, but only upon signal from a computer that it is time to take the medication. The device can be a stand alone device activated by a computer network signal or one activated by a mobile application on a cell phone, tablet, or similar.

For use via a mobile application, a wifi or a short range wireless receiver/transmitter would connect the pill dispenser to a computer app. The app sends a signal to the pill dispenser to only allow the number of pills prescribed at the interval prescribed to be dispensed from the pill dispenser. Patient compliance would be ensured. Optionally, the app could then connect via short range wireless, wifi, cellular or SMS to the physician's electronic medical record. The physician could also bidirectionally use his medical record to send a HIPPA compatible message via short range wireless, wifi, cellular or SMS to the mobile app to allow a change in the prescription.

The design of the device conceptually would be very simple. The mobile app or computer network would at certain time intervals alert and activate the fingerprint print biometric controller. The patient would confirm operation of the pill dispenser with a fingerprint which would when activate a digital combination lock to be input by the patient. The lock would allow operation of a shutter button as in a camera. When the shutter button is pressed once for one pain pill or twice for 2 pain pills one or two pills would be dispensed. The mechanics of the dispensing mechanism would resemble a robust “pen candy dispenser”.

### SUMMARY OF THE INVENTION

In one aspect, the invention provides a tamper proof system for dispensing prescription pills, in the manner prescribed, to a patient holding the prescription, the system comprising:

(a) a closed hollow storage container for pills having a pill dispenser connected to a shutter device that opens the container only upon communication with software on a personal computer; the storage container having a communication means comprising a short range wireless connectivity device to communicate with the personal computer;
(b) a personal computer installed with software, the personal computer having a fingerprint biometric lock, a means to input a digital combination lock code, and short range wireless connectivity device to communicate with the storage container;
(c) software that regulates the timing and number of pills to be dispensed according to the patient's prescription, wherein the software communicates with the storage container via the short range wireless connectivity device; and
(d) a tamper proof feature on the spring loaded shutter device, the feature comprising a cyano-acrylate;
wherein the software communicates a prescribed interval and number of pills to be dispensed to the storage container; and wherein upon a signal from the software on the personal computer, the patient activates, in sequence, the fingerprint biometric lock on the personal computer, inputs the digital combination code into the software on the personal computer and via a short range wireless signal the personal computer unlocks the shutter button on the storage container allowing only a controlled number of pills to be dispensed to the patient as prescribed after the patient pushes the now unlocked shutter on the storage container device.

In one embodiment, the personal computer further communicates with a remote computer comprising a physician electronic medical record (EMR) or a pharmacy computer via the software installed on the personal computer. In another embodiment the communication between the computer and the EMR is via short range wireless, SMS, cellular or wifi.

In another embodiment, the prescribed interval and number of pills dispensed can be changed by the electronic physician medical record by inputting a new prescription into the electronic physician medical record and communicating the new prescription to the software installed in the personal computer.

In one embodiment, the personal computer is a cellular phone, a tablet, a laptop computer, or a desk computer.

In one embodiment, the storage container is a square or rectangular box, an oval container, an oblong container, a cylindrical container, a or a pen-shaped container. In another embodiment, the storage container has a single internal unit for storing pills. In another embodiment, the storage container has multiple internal units for storing pills.

In one aspect, the present invention provides a tamper proof, stand alone system for dispensing prescription pills, in the manner prescribed, to a patient holding the prescription, the system comprising: a closed hollow storage container for pills having a pill dispenser connected to a spring loaded shutter device comprising a tamper proof feature; the storage container having a communication means comprising a short range wireless connectivity device or a wifi device to communicate with a remote computer; a fingerprint biometric lock, and a means to input a digital combination lock code; wherein the remote computer communicates a prescribed interval and number of pills to be dispensed to the storage container; and wherein upon a signal from the remote computer, the patient activates, in sequence, the fingerprint biometric lock on the storage container and inputs the digital combination code on the storage container, which unlocks the shutter button on the storage container allowing only a controlled number of pills to be dispensed to the patient as prescribed after the patient pushes the shutter on the storage container device.

In one embodiment, the remote computer is a physician electronic medical record (EMR) or a pharmacy computer.

In another embodiment, the prescribed interval and number of pills dispensed can be changed by the electronic physician medical record or pharmacy computer by inputting a new prescription into the electronic physician medical record and communicating the new prescription to the storage container.

In one embodiment, the storage container is a square or rectangular box, an oval container, an oblong container, a cylindrical container, a or a pen-shaped container.

In another embodiment, the storage container has a single internal unit for storing pills.

In another embodiment, the storage container has multiple internal units for storing pills.

Other features and advantages of aspects of the present invention will become apparent from the following more detailed description, taken in conjunction with the accompanying drawings, which illustrate, by way of example, the principles of aspects of the invention.

### BRIEF DESCRIPTION OF THE DRAWINGS

The accompanying drawings illustrate aspects of the present invention. In such drawings:

FIG. 1 is a schematic of a storage container for pills (front and back) paired with a personal computer.

FIG. 2 is a schematic of a stand alone storage container for pills (front and back).

FIG. 3 is a flow diagram of the process for unlocking the pill storage container unit, in accordance with at least one embodiment.

FIGS. 4A-D illustrate an embodiment of a spring loaded pill dispenser comprising a closed hollow storage container 12 from different views. FIG. 4A shows a side cross sectional view of the storage container 12 according to this embodiment; FIG. 4B is a perspective view of the storage container 12; FIG. 4C is a cross sectional side view of the pill magazine 13 which holds the individual pills 14; and FIG. 4D is a cross sectional schematic view of the pill magazine which illustrates the mechanical components of an exemplary embodiment.

FIGS. 5A-L show several images of iPhone screens displayed when used in accordance with embodiments of the invention. FIG. 5A shows an opening screen. FIG. 5B shows a log in screen. FIG. 5C shows a log in screen asking for personal pin. FIG. 5D shows a screen indicating next dose for cognitive behavioral therapy. FIG. 5E shows a screen of history of doses. FIG. 5F shows a screen for QR dose. FIG. 5G shows a screen for fingerprint confirmation allowing access to dose. FIG. 5H shows a screen of dose available, the time of dose, and the time of next dose. FIG. 5I shows a log in screen asking for personal code. FIG. 5J shows a screen to confirm access to iPill and that there is 5 minutes to get pill(s) from the iPill dispenser. FIG. 5K shows a log in screen asking for personal code. FIG. 5L shows a screen to confirm access to iPill and that there is 5 minutes to get pill(s) from the iPill dispenser.

FIGS. 6A-H show images of a pill dispenser in accordance to at least one embodiment of the invention and as used as described in Example I.

FIGS. 7A-E illustrate views of an exemplary embodiment of a kit in accordance to at least one embodiment of the invention and as used as described in Example II. FIG. 7A shows a QR Code type bar code reader that can be used in conjunction with the invention. FIG. 7B shows the top of the iPill with a green indicator light indicating that the iPill device is on device. FIG. 7C shows the side view of the iPill with a blue light to indicate that the iPill is connected to the app/phone and the charging site for where the charging cord will be inserted to charge the device. FIG. 7D shows the back of this embodiment of the iPill device. FIG. 7E shows a side view of the iPill showing the dispenser window where pills will be dispensed.

FIG. 8 is a side view of an iPill in accordance with at least one embodiment of the invention which illustrates the sliding door which opens the window where the pills are dispensed.

FIGS. 9A-C show three side perspective views of a pill storage container unit in accordance with at least one embodiment of the invention. FIG. 9A shows the oblique view of an iPill in accordance with at least one embodiment of the invention which displays a closed slide door where the pills will be dispensed. FIG. 9B shows the oblique view of the iPill which displays a slide door where the pills will be dispensed. FIG. 9C shows the oblique view of the iPill displays a blue light to indicate that the iPill is connected to the app/phone and the location where the charging cord will be inserted to charge the device.

FIGS. 10A-C show three schematic views of a pill storage container unit in accordance with at least one embodiment of the invention that depicts internal components from the three views. FIG. 10A depicts an open iPill where the cover is partially lifter. FIG. 10B displays the oblique view of the sliding door where the pills will be dispensed, the chamber where the pills will be held just prior to dispensing and the internal mechanism of the iPill including batteries 17, pill magazine 13, micro-controller/controller board 6, solenoid 18 and plunger device. FIG. 10C depicts the oblique view of the window where the pills will be dispensed, the pill magazine and the internal mechanism of the iPill including batteries 17, pill magazine 13, controller board 6, solenoid 18, the electrical connection to the battery, and plunger device.

FIG. 11A shows a front and FIG. 11B shows a side schematic view of a pill storage container unit in accordance with at least one embodiment of the invention.

The above described drawing figures illustrate aspects of the invention in at least one of its exemplary embodiments, which are further defined in detail in the following description. Features, elements, and aspects of the invention that are referenced by the same numerals in different figures represent the same, equivalent, or similar features, elements, or aspects, in accordance with one or more embodiments.

### DETAILED DESCRIPTION OF THE INVENTION

Once again, those skilled in the art will appreciate that a variety of other contexts and related systems and methods may be employed according to aspects of the present invention, in various combinations, without departing from the spirit and scope of the invention, such that those exemplary embodiments shown and described herein are to be understood as merely illustrative of aspects and features of the present invention and expressly non-limiting.

A “closed hollow storage container for pills” refers to a secure container for opioid or other controlled pills that has a locked shutter connected to a spring loaded pill dispenser. The shutter is unlocked, either directly or remotely, by a biometric fingerprint lock and a digital combination lock. The pill dispenser can have up to about 120 pills, with one pill dispensed per push of the shutter. The storage container communicates with a personal and/or a remote computer, which signals the timing and number of pills for delivery according to the patient's prescription. The communication with the personal and/or remote computer can be via short range wireless device (e.g., BLUETOOTH®), wifi, SMS, cellular, USB cable or other known means for computer communication via any wired or wireless network or means now known or later developed. The digital combination lock and/or fingerprint biometric lock can only be employed when the computer signals that it is time to take the prescribed number of pills.

The storage container can be any suitable compact and portable shape for dispensing pills, for example, a square or rectangular box, an oval container, an oblong container, a cylindrical container, a or a pen-shaped container. The container includes the pill dispenser, shutter device, power source, and wifi or short range wireless communication transceiver or device. Optionally, a stand alone storage container also includes a fingerprint biometric lock and a manual input for a digital combination lock, which when successfully operated by the patient directly unlocks the shutter. For a storage container paired with a personal computer, the personal computer has the fingerprint biometric lock and a means to enter the digital combination lock code, which unlocks the shutter via wireless communication.

To unlock the pill storage container, the fingerprint biometric lock and the digital combination lock must be unlocked in sequence, no later than 10 seconds, 20 seconds, 30 seconds, 40 seconds, 50 seconds, one, two, three, four or five minutes between implementing the fingerprint biometric signal and inputting the digital biometric lock code.

The “tamper proof feature” of the spring loaded pill dispenser is a cyanoacrylate. If the shutter mechanism is opened with out the required fingerprint biometric lock and digital combination lock sequence (timed), the tamper proof feature will coat the pills in the pill dispenser with a cyanoacrylate. Embodiments of suitable cyanoacrylates include methyl cyanoacrylate, ethyl cyanoacrylate, N-butyl cyanoacrylate and 2-octyl cyanoacrylate.

The personal computer is configured with HIPPA compliant software, “the controller app.” The fingerprint biometric lock is typically operated by the personal computer operating system, while the digital combination lock is typically operated by the controller app. Once the fingerprint biometric lock and the digital combination lock are successfully operated by the patient, the controller app signals the paired storage container and unlocks the shutter mechanism. The controller app can also store data regarding the number of pills and the interval between pill dispensing.

The storage container can have one, two or more pill dispensers connected to a shutter device.

“Dispensing pills in the manner prescribed” refers to regulating the number of pills and the time that they can be administered in accordance with the patient's prescription. Regulation is performed via the HIPPA compliant “controller app,” e.g., installed on a personal computer or by a software program run by a remote computer such as a physician electronic medical (EMR) or pharmacy computer.

“Tamper proof” refers to a device or system that prevents unauthorized use, via the combination of a biometric fingerprint lock and a digital combination lock.

“Personal computer” refers to a mobile or smart phone, optical device including glasses and contacts, tablet, laptop, desktop or computer network that has an app (the “controller or dispensing app”) in one iteration, controlling the storage device, where the personal computer is controlled by a patient or a designated, authorized surrogate such as a nurse, a family member, a law enforcement officer, a substance abuse counselor, an aide, etc.

“Remote computer” refers to a physician or pharmacy computer that is configured with appropriate HIPPA compliant software and communicates with a storage container. The remote computer is controlled by a licensed professional such as a medical doctor, a nurse, or a pharmacist in compliance with HIPPA.

A “stand alone” storage container is one that is not linked to or paired with a personal computer, but that communicates directly with the remote computer.

“Digital combination lock” is a code that is input either into an app in a personal computer, or directly into the stand alone storage container.

“Fingerprint biometric lock” is a lock activated by an individual fingerprint, and is located on the personal computer or the stand alone storage container. The fingerprint biometric lock and the digital combination lock act together to provide suitable security for the device. The digital combination lock code can only be input into the stand alone device or the controller app at a time or interval designated by the patient's prescription.

It should be noted that the term “memory” is intended to include any type of electronic storage medium (or combination of storage mediums) now known or later developed, such as local hard drives, RAM, flash memory, external storage devices, network or cloud storage devices, etc.

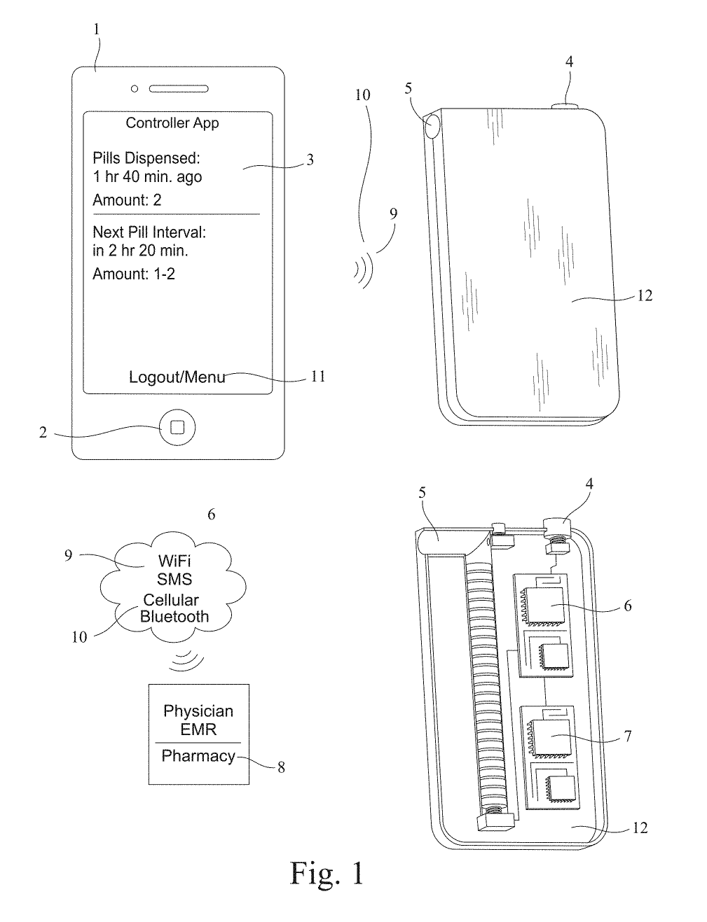

Turning now to FIG. 1, there is shown a schematic diagram of an exemplary storage container for pills that is controlled by a personal computer, in this embodiment, a smart phone with a controller app. A smart phone 1 has a fingerprint biometric lock 2, a controller app 3 and as part of the controller app, a means for inputting a digital lock code 11. The smart phone has short range wireless transponder 10 or wifi transponder 9, which communicates with the storage container. The front view of the storage container 12 shows a shutter 4 and a pill dispenser 5. The back view of the storage container 12 shows a shutter 4, a spring loaded pill dispenser with a tamper proof feature comprising a cyano-acrylate 5, a short range wireless microcontroller 6 and a power source 7. Upon a signal from the controller app 3 on the personal computer 1, the patient unlocks the biometric fingerprint lock 2 and uses the controller app 3 to input the digital lock code. This sequence communicates with the storage container 12 via short range wireless signal 10 and unlocks the shutter 4. When pressed, shutter 4 opens the pill dispenser 5 and a single pill is dispensed per shutter action. The controller app 3 stores data regarding the interval and number of pills taken. The personal computer 1 can also communicate the data via short range wireless 10, or wifi, SMS or cellular 9 with a remote computer 8. The remote computer 8 can for example be a physician electronic medical record or a pharmacy computer. An authorized user of the EMR or pharmacy computer can change the patient's prescription and communicate the changes to the controller app 3. The changes to the prescription can be the timing or interval of the drug dose, or the amount of the drug dose.

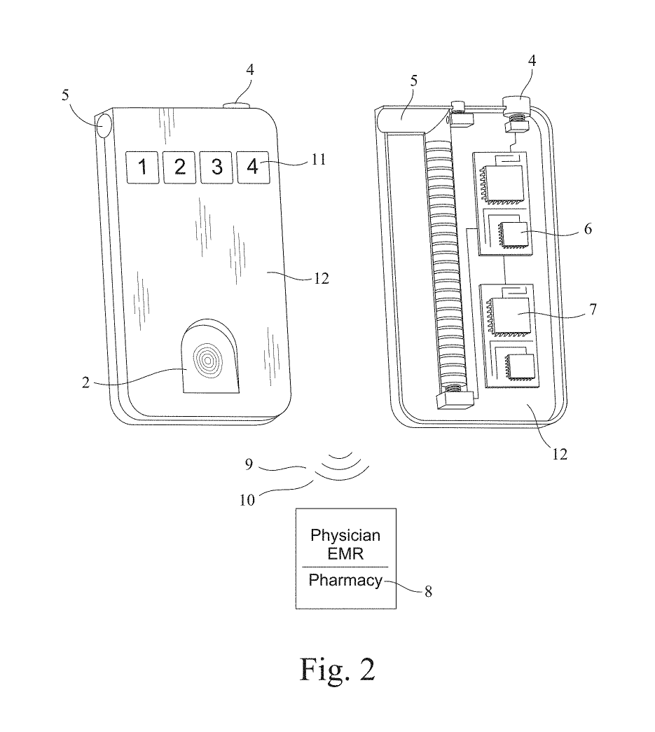

FIG. 2 shows a schematic diagram of a stand alone storage container for pills that is controlled by a remote computer. The front view of the storage container 12 shows a fingerprint biometric lock 2 and a digital combination lock 11. The back view of the storage container 12 shows a shutter 4, a spring loaded pill dispenser with a tamper proof feature comprising a cyano-acrylate 5, a short range wireless or wifi microcontroller 6 and a power source 7. The stand alone storage container 12 can communicate via short range wireless 10, or wifi 9 with a remote computer 8. Upon a short range wireless signal 10, or a wifi signal 9 from the remote computer 8, the patient unlocks the biometric fingerprint lock 2 and inputs the code into the digital combination lock 11. This sequence unlocks the shutter 4. When pressed, shutter 4 opens the pill dispenser 5 and a single pill is dispensed per shutter action. The remote computer 8 can for example be a physician electronic medical record or a pharmacy computer. An authorized user of the EMR or pharmacy computer can change the patient's prescription and communicate the changes by signaling via short range wireless signal 10 or wifi signal 9 to the stand alone storage container that it is time for the patient to take a pill, or signal that the number of pills (shutter depressions) has changed. The changes to the prescription can be the timing or interval of the drug dose, or the amount of the drug dose.

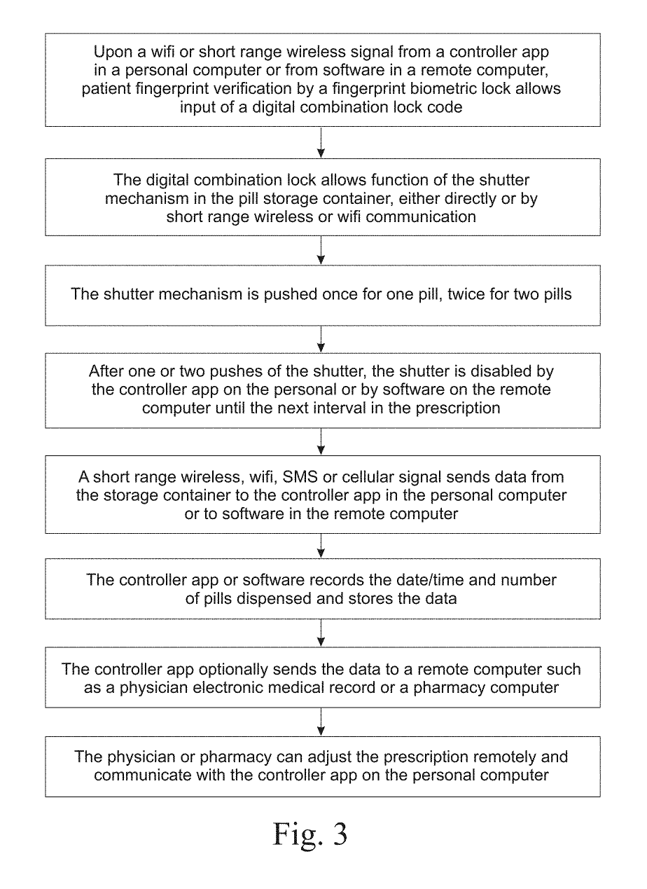

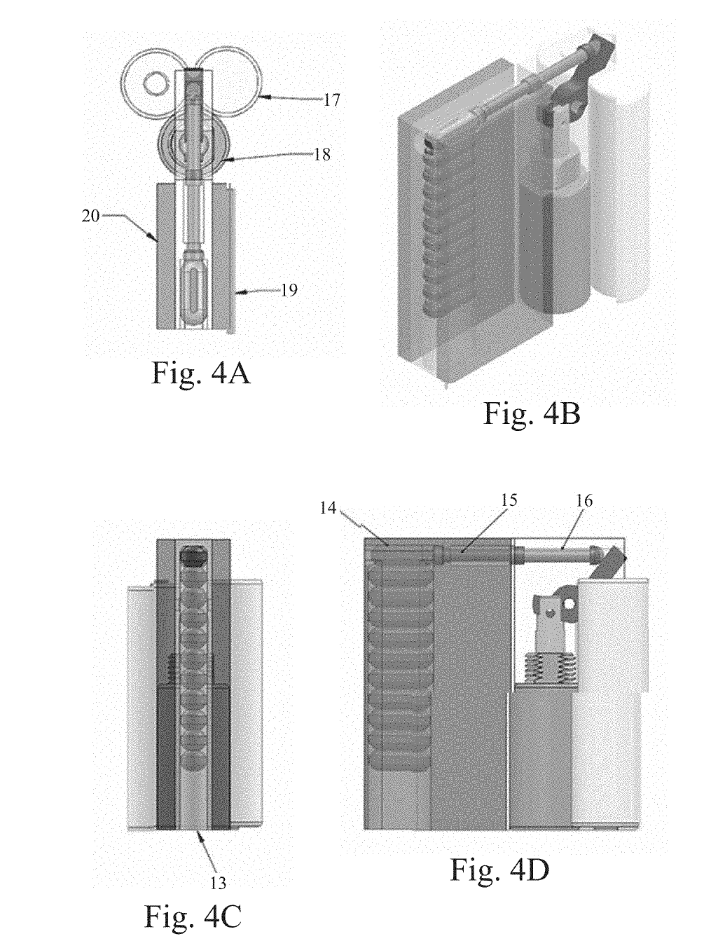

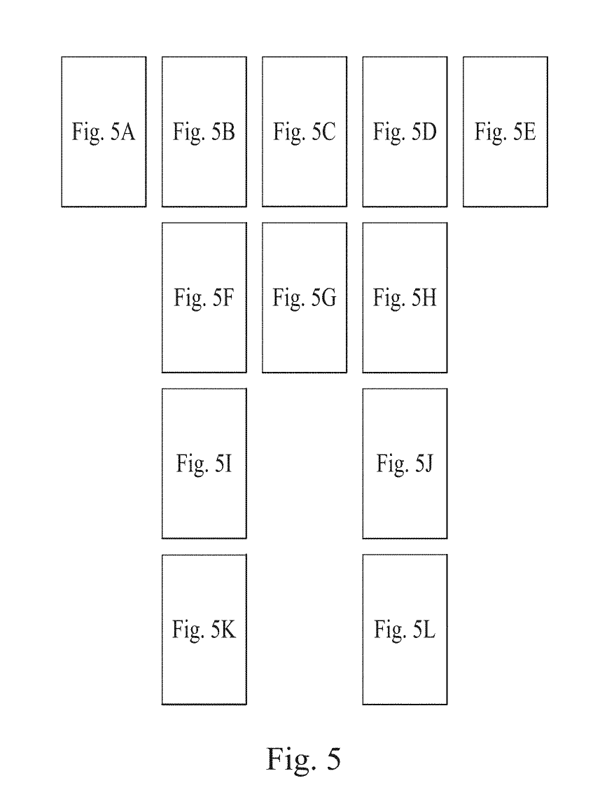

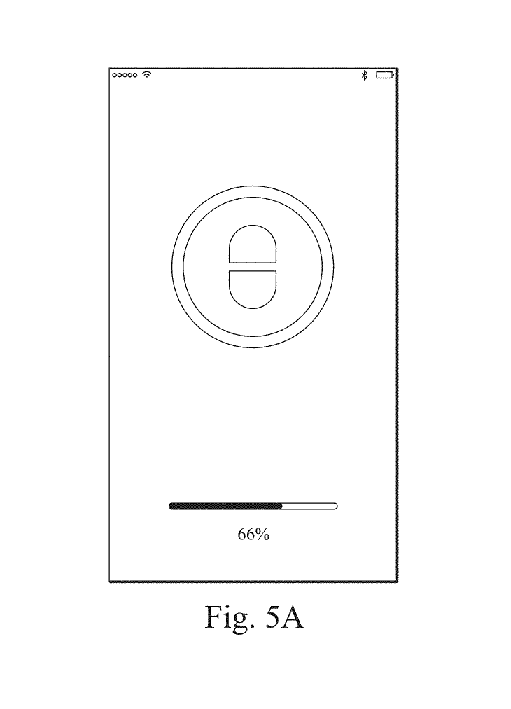

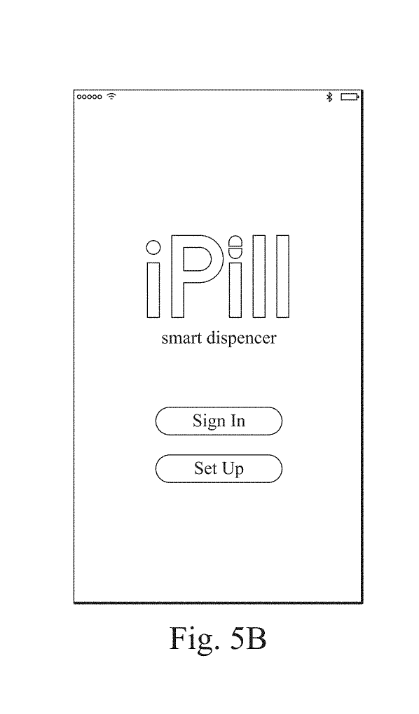

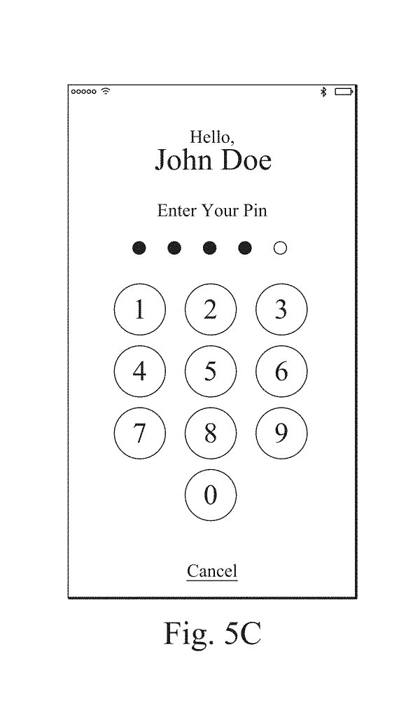

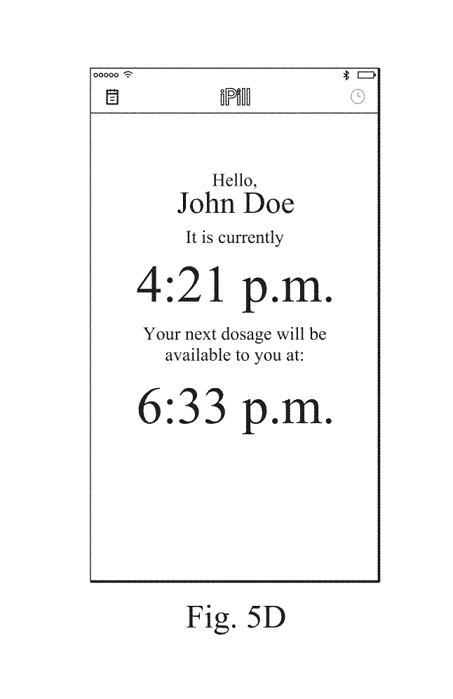

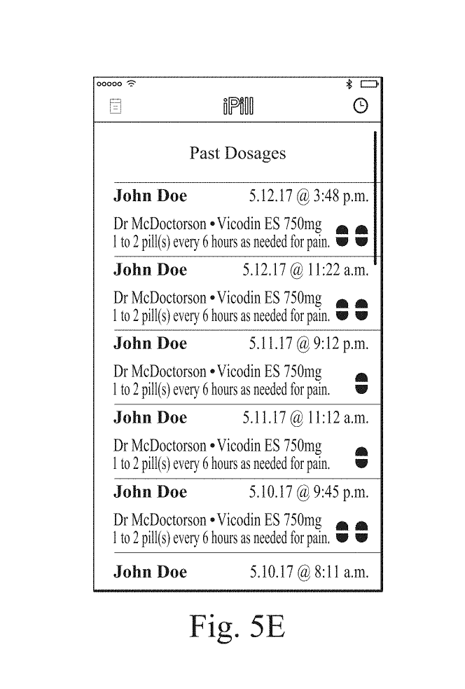

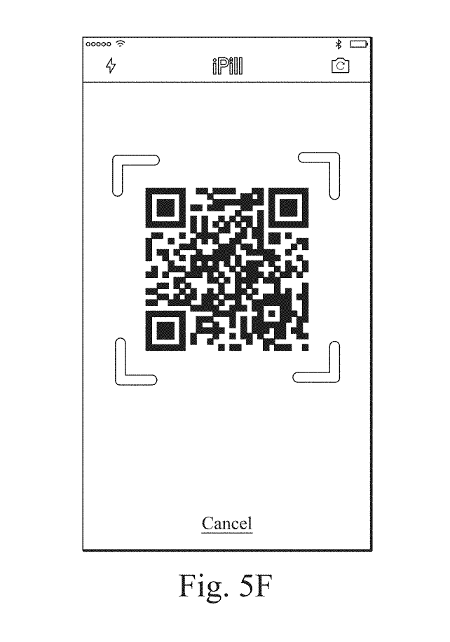

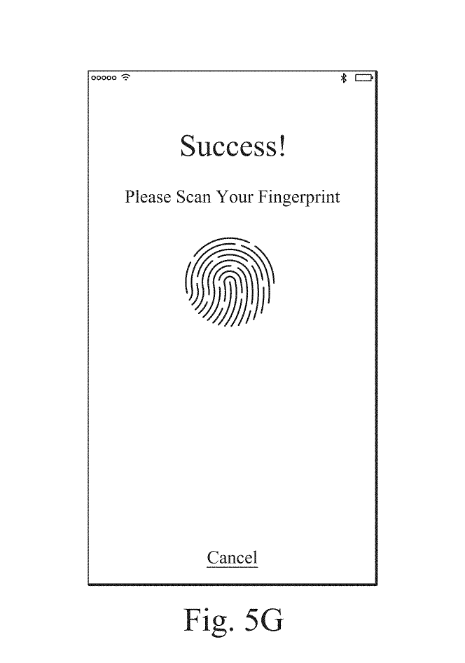

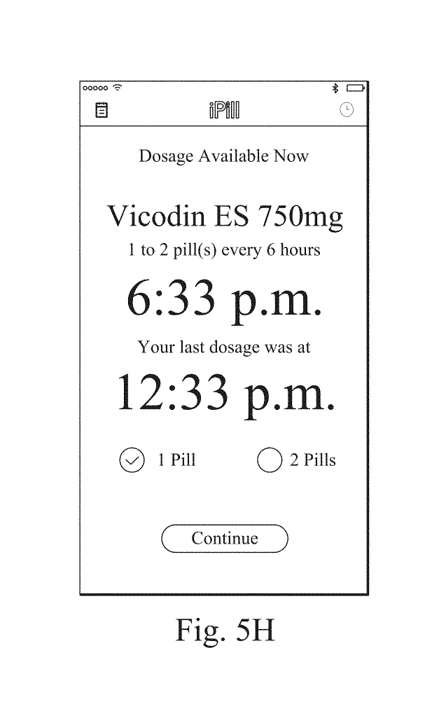

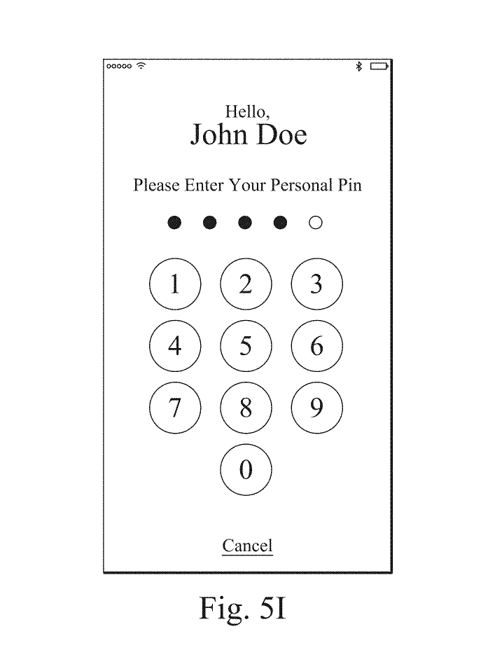

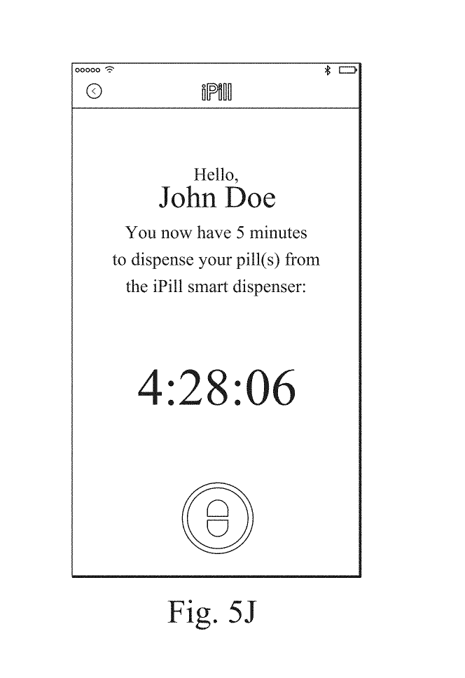

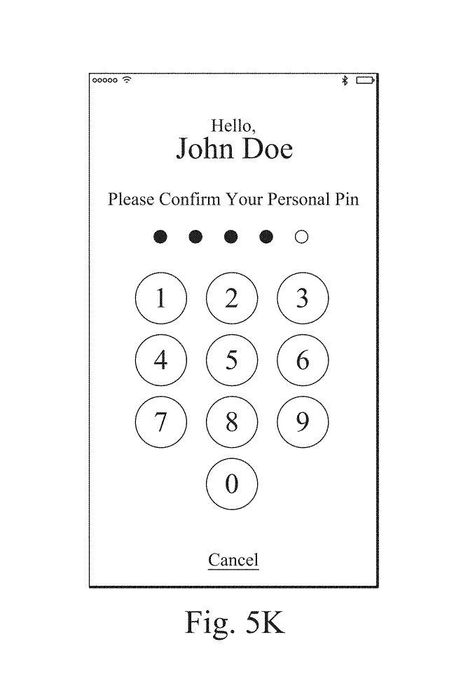

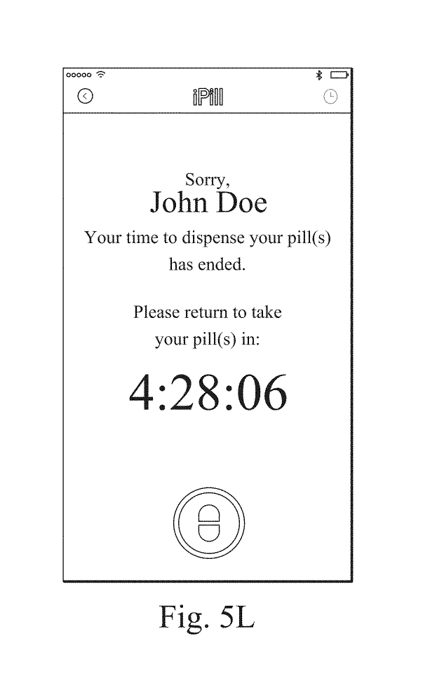

The flow chart of FIG. 3 describes the method of operation of the paired or stand alone storage container.

FIGS. 4A-D show a detailed schematic diagram of an embodiment of a spring loaded pill dispenser comprising a closed hollow storage container 12 from different views to illustrate basic mechanical features and operational components of a representative storage container 12. The dimensions provided in this embodiment are non-limiting examples of this embodiment, and other sizes and dimensions are envisioned. FIG. 4A shows a side cross sectional view of the storage container 12 according to this embodiment. In this view, two batteries 17 are shown disposed above the solenoid 18. Also seen in this view are the UI/control space 19 and an electronics space 20. FIG. 4B is a perspective view of the storage container 12. FIG. 4C is a cross sectional side view of the pill magazine 13 which holds the individual pills 14. FIG. 4D is a cross sectional schematic view of the pill magazine 13 which illustrates the magazine drive shaft 15 in operable connection with the drive shaft 16, which in turn is in operable connection with the solenoid 18.

In typical, but non-limiting, use of the embodiment in FIG. 4, a patient uses their own phone and downloads an app form a website provided to the patient. Once the app is downloaded it must be activated. The app asks for a 4 digit security code. The 4 digit security code is entered again for confirmation. The patient opens the app which then asks for a fingerprint. Confirmation of the fingerprint appears on the screen. The app will ask to register the patient's prescription which is coded on the QR code. The camera on the phone opens a QR scanner within the app which reads the code. With the iPill™ (hereinafter iPILL) dispenser on, the phone will connect via an IoT encrypted signal. A count down timer will appear to indicate when the next dose is available. When the time is appropriate to take a dose of medication an alarm will go off on the phone. The patient opens the phone, scans the fingerprint and enters their personal code. 1-2 pills will typically automatically dispense. The dock starts for the next dosing interval, and no pills can be dispensed before the time interval on the prescription. The iPill dispenser is tamperproof. Should it be dropped or an attempt is made to open it, the gel packet inside will contact all pills and form and inedible brick. The iPill dispenser will also prevent diversion. A random number generator will convert the personal code, finger print and OR code into a random number to be stored in the phone and the iPill dispenser. Therefore only that particular phone will only be able to open that particular iPill dispenser once setup is complete. The iPill dispenser will also prevent overconsumption of opioids because the dosing procedure is required and will only operate the iPill dispenser at the time interval specified on the prescription.

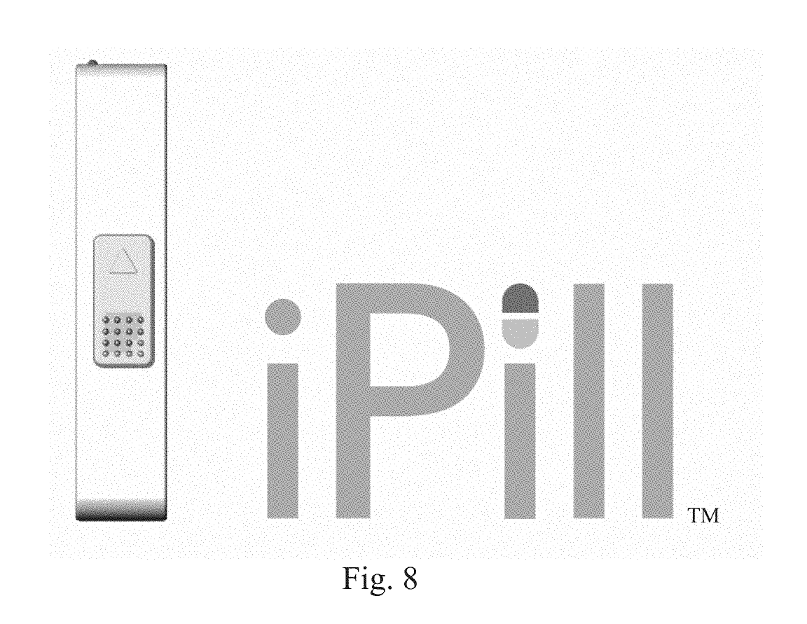

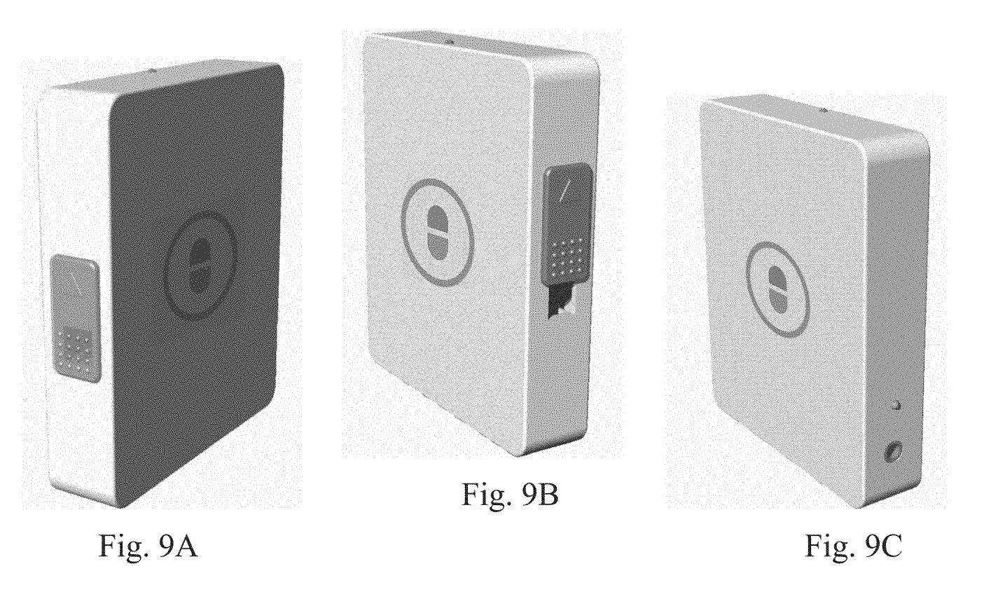

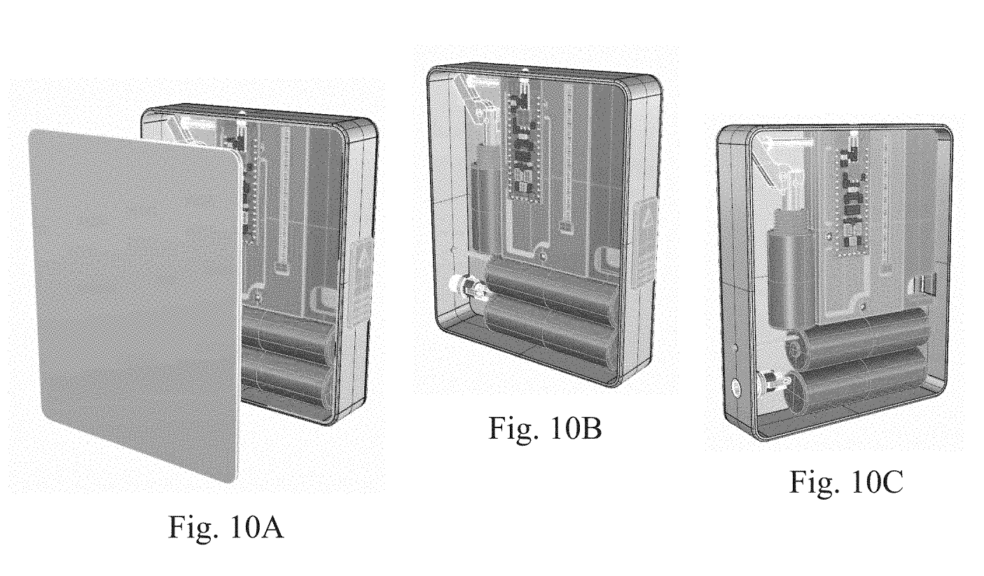

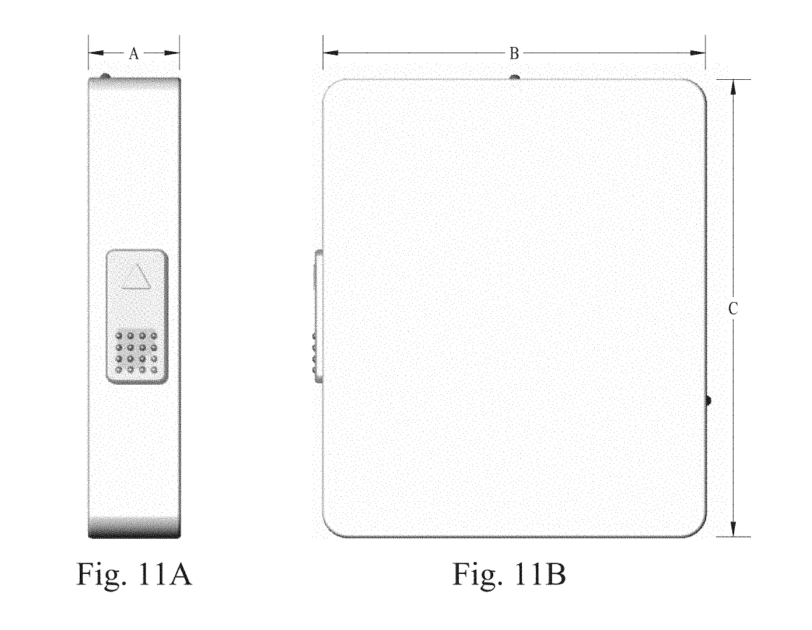

An iPill dispenser is not limited to any particular size, shape, or dimension in design. Representative non-limiting embodiments are shown in FIGS. 8-11. For an embodiment shown in FIG. 11B, a suitable width (A) for an iPill dispenser is between about 2.5 cm and about 10.0 cm, and is about 2.5 cm in one particular embodiment. A suitable depth (B) for an iPill dispenser is between about 10.0 cm and about 20.0 cm, and is about 10.5 cm in one particular embodiment. A suitable height (C) for an iPill dispenser is between about 12.0 cm and about 18.0 cm, and is about 12.5 cm in one particular embodiment.

### EXAMPLES

The following non-limiting examples are provided for illustrative purposes only in order to facilitate a more complete understanding of representative embodiments now contemplated. These examples are intended to be a mere subset of all possible contexts in which the storage container 12 may be utilized. Thus, these examples should not be construed to limit any of the embodiments described in the present specification, including those pertaining to the storage container 12 and/or methods and uses thereof.

### Example 1—Operation of an Exemplary the Storage Container 12 Utilizing an iPhone

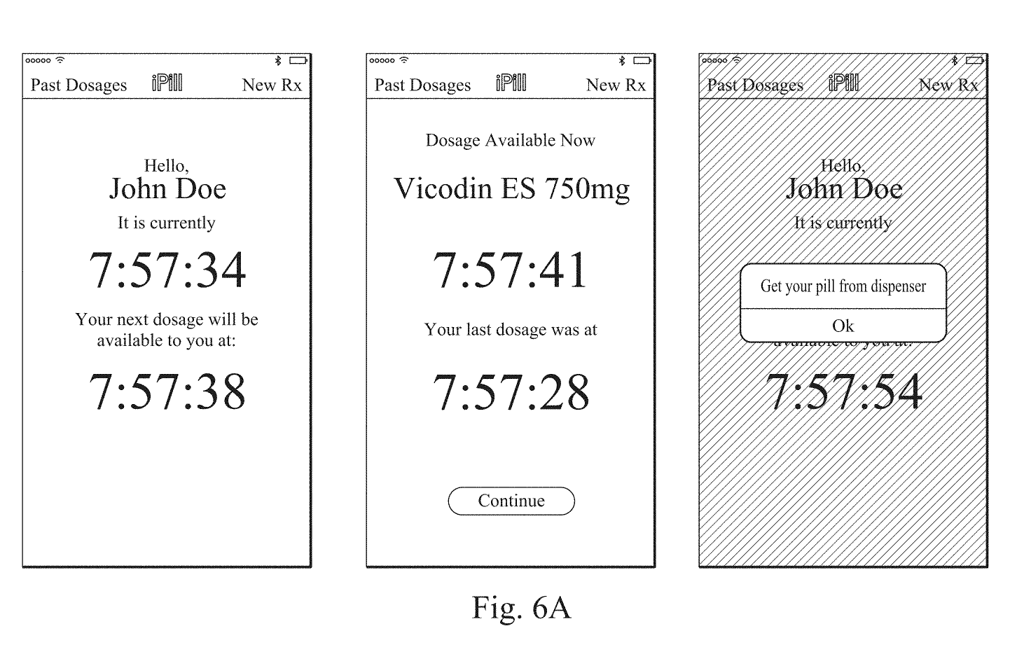

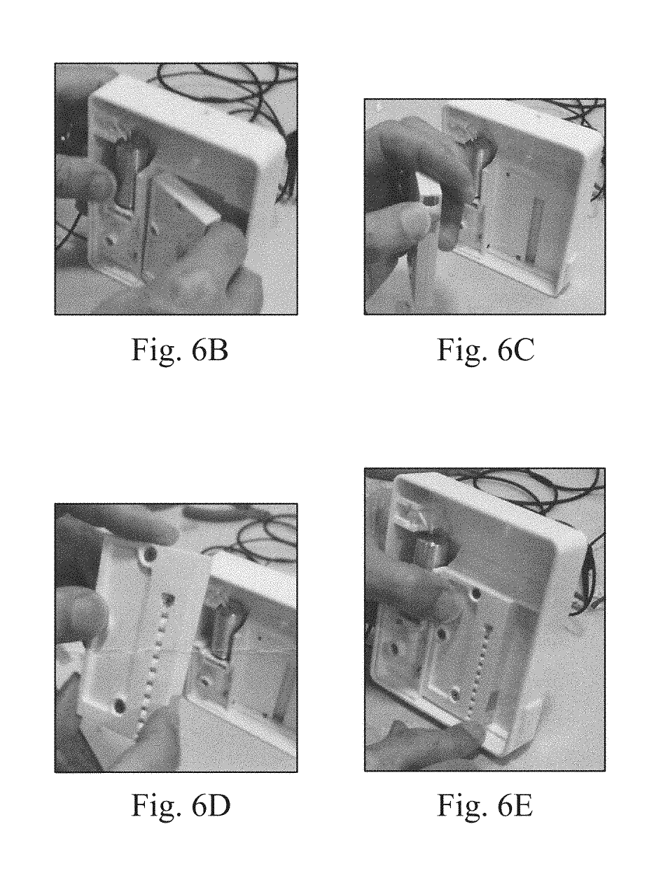

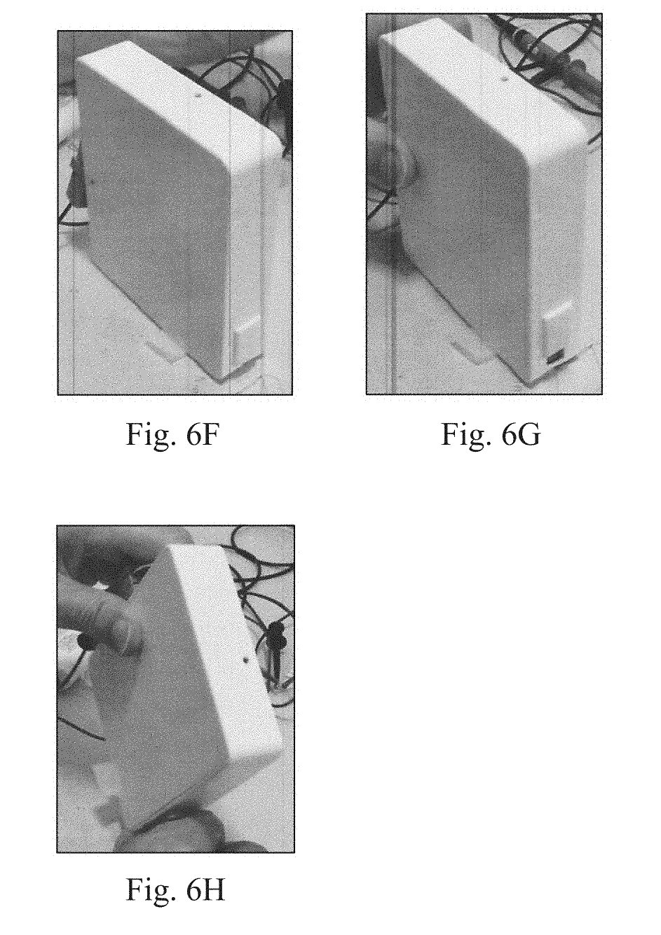

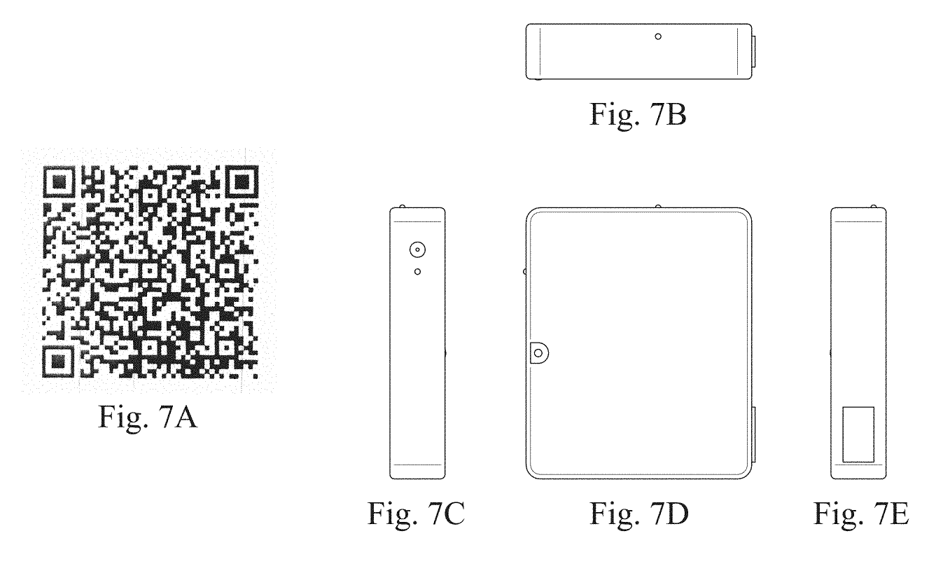

Prior to operation, set up as follows:
set an iPill according to the invention upright, with the status LED at the top
note: the iPill magazine is gravity fed, so it is important to demo the unit in the upright ‘playing’ position
remove the dummy plug
the iPill can be operated with a full (10 pill) magazine or with a partially full magazine, however, be sure the pills are stacked flat in the dispenser and the platform is resting on top of the pill stack in the correct position
The steps below are made with reference to FIG. 6 and FIG. 7.

1. Remove the dummy plug and confirm the green LED status light starts blinking.

2. Power up and unlock the iPhone. The iPhone security code is 2222222.

3. Start the iPhone App

4. The first time you start the App you will need to enter and confirm a 4 digit security code for the App.

5. Then record your finger print.

6. The App will ask you to register your prescription by reading a QR code. The correct demo QR Code is provided above.

7. If the Prototype is on, the iPhone will connect with the Prototype via Bluetooth. The Blue LED on the iPill near the charging port will light to confirm BT connection.

8. The App will go into its ‘countdown’ screen to let you know its timing until the next dispense (FIG. 6A).

9. When the time interval is reached (10 seconds for this demo version) the system will go to the ready screen and the Status light on the iPill will turn solid green (FIG. 6A).

10. Press Continue to dispense a pill (FIG. 6A).

11. You will hear the Solenoid fire and the screen will change to instruct you to retrieve your pill—open the door by sliding it up and you can get the pill by gently tipping the iPill forward.

12. Close the pill door and replace the iPill to its upright position to continue operating.

13. When the iPill is empty, the system will tell you that you need a new prescription.

14. The pill magazine will hold 10 pcs Acetaminophen 500 mg tablets (such as generic).

15. Open iPill protpotype by removing the cover.

16. While holding the iPill in its upright playing position, remove the magazine from the iPill (FIG. 6B).
Note: that the firing mechanism is gravity assisted, so the plunger should be fully retracted from the magazine when the remove takes place. Rotating the iPill out of the upright position may cause the plunger to extend, making the replacement of the magazine difficult.

17. Hold the magazine upright but with the pill gate near the top (upside down from the playing position) (FIG. 6C).

18. Be sure the Pill platform has slid to the bottom of its travel and is resting in a flat position (FIG. 6D).

19. Gently hold the clear door flap aside, and slide the pills into the gate and allow them to drop fully into the Magazine. Do not crease the clear flap door. (FIG. 6D).

20. Confirm each pill is resting flat on the ones beneath it before inserting more.

21. Once all ten pills are installed, replace the Magazine in the iPill and confirm it is fully seated before closing the unit (FIG. 6E).

Resetting the App. To reset, exit the App. and close it fully using the iPhone standard protocol (double click the Home button and swipe the App image up) (FIG. 6F).

Resetting the iPill Controller. The iPill is provided with an internal reset button which will perform a hard reset of the internal microcontroller when pressed (FIG. 6G, 6H).

### Example II—Operation of a Kit that Utilizes a Storage Container

An iPill phase I prototype kit may include:
an iPill prototype provided herein
a preconfigured iPhone 6S
a battery charger with adapter
a dummy plug

A schematic illustration of an iPill kit and directions for use are shown in FIG. 7.

Battery power
the battery is permanently connected to the iPill electronics
to disconnect insert the dummy plug into the charging port
use the dummy plug to power off the unit when storing or shipping the unit to save the battery charge and assure the unit is off
the iPill prototype is provided with a dual cell lithium ion 2.2AH rechargeable battery. This batter has been certified to comply with UN38.3
the unit should be charged only with the charger and adapter provided. Charging instructions are provided separately with the charger.

Setting up the prototype prior to operation:
Open the iPill prototype by removing the cover screw and lifting the cover out and off of the unit.
Inspect to confirm the magazine is fully loaded with pills and seated firmly in the chassis location
Close the iPill and cover screw

Aspects of the present specification may also be described as follows:

A first embodiment (1) is directed to a tamper proof system for dispensing prescription pills, in the manner prescribed, to a patient holding the prescription, the system comprising: (a) a closed hollow storage container for pills having a pill dispenser connected to a spring-loaded shutter device that opens the container only upon communication with software on a personal computer; the storage container having a communication means comprising a short range wireless connectivity device to communicate with the personal computer; (b) a personal computer installed with software, the personal computer having a fingerprint biometric lock, a means to input a digital combination lock code, and short range wireless connectivity device to communicate with the storage container; (c) software that regulates the timing and number of pills to be dispensed according to the patient's prescription, wherein the software communicates with the storage container via the short range wireless connectivity device; and (d) a tamper proof feature on the spring loaded shutter device, the feature comprising a cyano-acrylate; wherein the software communicates a prescribed interval and number of pills to be dispensed to the storage container; and wherein upon a signal from the software on the personal computer, the patient activates, in sequence, the fingerprint biometric lock on the personal computer, inputs the digital combination code into the software on the personal computer within the prescribed dispensing window and via a short range wireless signal the personal computer unlocks the shutter button on the storage container allowing only a controlled number of pills to be dispensed to the patient as prescribed after the patient pushes the now unlocked shutter on the storage container device.

Another embodiment (2) comprises the system of embodiment 1, wherein the personal computer further communicates with a remote computer comprising a physician electronic medical record (EMR) or a pharmacy computer via the software installed on the personal computer.

Another embodiment (3) comprises the system of embodiment 1, wherein the communication between the computer and the EMR is via short range wireless, SMS, cellular or wifi.

Another embodiment (4) comprises the system of embodiment 2, wherein the prescribed interval and number of pills dispensed can be changed by the electronic physician medical record by inputting a new prescription into the electronic physician medical record and communicating the new prescription to the software installed in the personal computer.

Another embodiment (5) comprises the system of embodiment 1, wherein the personal computer is a cellular phone, a tablet, a laptop computer, or a desk computer.

Another embodiment (6) comprises the system of embodiment 1, wherein the storage container is a square or rectangular box, an oval container, an oblong container, a cylindrical container, a or a pen-shaped container.

Another embodiment (7) comprises the system of embodiment 1, wherein the storage container has a single internal unit for storing pills.

Another embodiment (8) comprises the system of embodiment 1, wherein the storage container has multiple internal units for storing pills.

Another embodiment (9) comprises a tamper proof, stand alone system for dispensing prescription pills, in the manner prescribed, to a patient holding the prescription, the system comprising: a closed hollow storage container for pills having a spring loaded pill dispenser connected to a shutter device, wherein the spring loaded shutter device has a tamper proof feature comprising cyano-acrylate; the storage container having a communication means comprising a short range wireless connectivity device or a wifi device to communicate with a remote computer; a fingerprint biometric lock, and a means to input a digital combination lock code; wherein the remote computer communicates a prescribed interval and number of pills to be dispensed to the storage container; and wherein upon a signal from the remote computer, the patient activates in sequence the fingerprint biometric lock on the storage container and inputs the digital combination code on the storage container within the dispensing window, which unlocks the shutter button on the storage container allowing only a controlled number of pills to be dispensed to the patient as prescribed after the patient pushes the shutter on the storage container device.

Another embodiment (10) comprises the system of embodiment 9, wherein the remote computer is a physician electronic medical record (EMR) or a pharmacy computer.

Another embodiment (11) comprises the system of embodiment 2, wherein the prescribed interval and number of pills dispensed can be changed by the electronic physician medical record or pharmacy computer by inputting a new prescription into the electronic physician medical record and communicating the new prescription to the storage container.

Another embodiment (12) comprises the system of embodiment 1, wherein the storage container is a square or rectangular box, an oval container, an oblong container, a cylindrical container, a or a pen-shaped container.

Another embodiment (13) comprises the system of embodiment 1, wherein the storage container has a single internal unit for storing pills.

Another embodiment (14) comprises the system of embodiment 1, wherein the storage container has multiple internal units for storing pills.

In closing, regarding the exemplary embodiments of the present invention as shown and described herein, it will be appreciated that a tamper proof pill dispenser system, along with associated methods of use, is disclosed. Because the principles of the invention may be practiced in a number of configurations beyond those shown and described, it is to be understood that the invention is not in any way limited by the exemplary embodiments and is able to take numerous forms without departing from the spirit and scope of the invention. It will also be appreciated by those skilled in the art that the present invention is not limited to the particular geometries and materials of construction disclosed, but may instead entail other functionally comparable structures or materials, now known or later developed, without departing from the spirit and scope of the invention. Furthermore, the various features of each of the above-described embodiments may be combined in any logical manner and are intended to be included within the scope of the present invention.

Groupings of alternative embodiments, elements, or steps of the present invention are not to be construed as limitations. Each group member may be referred to and claimed individually or in any combination with other group members disclosed herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Unless otherwise indicated, all numbers expressing a characteristic, item, quantity, parameter, property, term, and so forth used in the present specification and claims are to be understood as being modified in all instances by the term “about.” As used herein, the term “about” means that the characteristic, item, quantity, parameter, property, or term so qualified encompasses a range of plus or minus ten percent above and below the value of the stated characteristic, item, quantity, parameter, property, or term. Accordingly, unless indicated to the contrary, the numerical parameters set forth in the specification and attached claims are approximations that may vary. At the very least, and not as an attempt to limit the application of the doctrine of equivalents to the scope of the claims, each numerical indication should at least be construed in light of the number of reported significant digits and by applying ordinary rounding techniques. Notwithstanding that the numerical ranges and values setting forth the broad scope of the invention are approximations, the numerical ranges and values set forth in the specific examples are reported as precisely as possible. Any numerical range or value, however, inherently contains certain errors necessarily resulting from the standard deviation found in their respective testing measurements. Recitation of numerical ranges of values herein is merely intended to serve as a shorthand method of referring individually to each separate numerical value falling within the range. Unless otherwise indicated herein, each individual value of a numerical range is incorporated into the present specification as if it were individually recited herein.

The terms “a,” “an,” “the” and similar referents used in the context of describing the present invention (especially in the context of the following claims) are to be construed to cover both the singular and the plural, unless otherwise indicated herein or clearly contradicted by context. All methods described herein can be performed in any suitable order unless otherwise indicated herein or otherwise clearly contradicted by context. The use of any and all examples, or exemplary language (e.g., “such as”) provided herein is intended merely to better illuminate the present invention and does not pose a limitation on the scope of the invention otherwise claimed. No language in the present specification should be construed as indicating any non-claimed element essential to the practice of the invention.

Specific embodiments disclosed herein may be further limited in the claims using consisting of or consisting essentially of language. When used in the claims, whether as filed or added per amendment, the transition term “consisting of” excludes any element, step, or ingredient not specified in the claims. The transition term “consisting essentially of” limits the scope of a claim to the specified materials or steps and those that do not materially affect the basic and novel characteristic(s). Embodiments of the present invention so claimed are inherently or expressly described and enabled herein.

It should be understood that the logic code, programs, modules, processes, methods, and the order in which the respective elements of each method are performed are purely exemplary. Depending on the implementation, they may be performed in any order or in parallel, unless indicated otherwise in the present disclosure. Further, the logic code is not related, or limited to any particular programming language, and may comprise one or more modules that execute on one or more processors in a distributed, non-distributed, or multiprocessing environment.

While aspects of the invention have been described with reference to at least one exemplary embodiment, it is to be clearly understood by those skilled in the art that the invention is not limited thereto. Rather, the scope of the invention is to be interpreted only in conjunction with the appended claims and it is made clear, here, that the inventor(s) believe that the claimed subject matter is the invention.

1. A tamper proof system for dispensing prescription pills, in the manner prescribed, to a patient holding the prescription, the system comprising:
(a) a closed hollow storage container for pills having a pill dispenser connected to a spring-loaded shutter device that opens the container only upon communication with software on a personal computer; the storage container having a communication means comprising a short range wireless connectivity device to communicate with the personal computer;
(b) a personal computer installed with software, the personal computer having a fingerprint biometric lock, a means to input a digital combination lock code, and short range wireless connectivity device to communicate with the storage container;
(c) software that regulates the timing and number of pills to be dispensed according to the patient's prescription, wherein the software communicates with the storage container via the short range wireless connectivity device; and
(d) a tamper proof feature on the spring loaded shutter device, the feature comprising a cyano-acrylate;
wherein the software communicates a prescribed interval and number of pills to be dispensed to the storage container; and wherein upon a signal from the software on the personal computer, the patient activates, in sequence, the fingerprint biometric lock on the personal computer, inputs the digital combination code into the software on the personal computer within the prescribed dispensing window and via a short range wireless signal the personal computer unlocks the shutter button on the storage container allowing only a controlled number of pills to be dispensed to the patient as prescribed after the patient pushes the now unlocked shutter on the storage container device.

2. The system of claim 1, wherein the personal computer further communicates with a remote computer comprising a physician electronic medical record (EMR) or a pharmacy computer via the software installed on the personal computer.

3. The system of claim 2, wherein the communication between the computer and the EMR is via short range wireless, SMS, cellular or wifi.

4. The system of claim 2, wherein the prescribed interval and number of pills dispensed can be changed by the electronic physician medical record by inputting a new prescription into the electronic physician medical record and communicating the new prescription to the software installed in the personal computer.

5. The system of claim 1, wherein the personal computer is a cellular phone, a tablet, a laptop computer, or a desk computer.

6. The system of claim 1, wherein the storage container is a square or rectangular box, an oval container, an oblong container, a cylindrical container, a or a pen-shaped container.

7. The system of claim 1, wherein the storage container has a single internal unit for storing pills.

8. The system of claim 1, wherein the storage container has multiple internal units for storing pills.

9. A tamper proof, stand alone system for dispensing prescription pills, in the manner prescribed, to a patient holding the prescription, the system comprising:
a closed hollow storage container for pills having a spring loaded pill dispenser connected to a shutter device, wherein the spring loaded shutter device has a tamper proof feature comprising cyano-acrylate; the storage container having a communication means comprising a short range wireless connectivity device or a wifi device to communicate with a remote computer; a fingerprint biometric lock, and a means to input a digital combination lock code;
wherein the remote computer communicates a prescribed interval and number of pills to be dispensed to the storage container; and wherein upon a signal from the remote computer, the patient activates in sequence the fingerprint biometric lock on the storage container and inputs the digital combination code on the storage container within the dispensing window, which unlocks the shutter button on the storage container allowing only a controlled number of pills to be dispensed to the patient as prescribed after the patient pushes the shutter on the storage container device.

10. The system of claim 9, wherein the remote computer is a physician electronic medical record (EMR) or a pharmacy computer.

11. The system of claim 2, wherein the prescribed interval and number of pills dispensed can be changed by the electronic physician medical record or pharmacy computer by inputting a new prescription into the electronic physician medical record and communicating the new prescription to the storage container.

12. The system of claim 1, wherein the storage container is a square or rectangular box, an oval container, an oblong container, a cylindrical container, a or a pen-shaped container.

13. The system of claim 1, wherein the storage container has a single internal unit for storing pills.

14. The system of claim 1, wherein the storage container has multiple internal units for storing pills.
